(19) United States
(12) Patent Application Publication
(10) Pub. No.: US 2007/0130841 A1
(43) Pub. Date: Jun. 14, 2007

(54) Construction module system and method

(76) Inventor: Richard V. Bays, Houston, TX (US)

Correspondence Address: LOCKE LIDDELL & SAPP LLP, 600 TRAVIS, 3400 CHASE TOWER, HOUSTON, TX, 77002-3095, US

(21) Appl. No.: 11/301,185

(22) Filed: Dec. 12, 2005

(51) Int. Cl. B62D 63/04; E04B 1/34

(52) U.S. Cl. 52/3

(57) ABSTRACT

The present invention provides a simplified construction module system and method to form a structure by a minimal crew with little specalized trade skills and minimum equipment in a relatively short time period. Relatively lighweight construction modules can be brought to a construction site and linked together to form the structure. In at least one embodiment the present invention includes foundation modules, wall modules, ceiling modules, and roof modules. Further, the modules can be subdivided into specific modules that can be interchanged with other modules, including a door module, window module, and sub-modules. A designer can simply choose between the various modules depending on the size and layout desired. Other building trades such as finishers, plumbing, and electrical can complete the structure as needed. One or more of the modules can be filled after erection on the jobsite with a filler to add strength or stability to the structure.

### FIELD OF THE INVENTION

The present invention relates to the construction industry. More specifically, the present invention relates to modular construction of buildings.

### BACKGROUND OF THE INVENTION

Present day construction of a typical building involves extensive time, materials, and attendant costs. This known fact is especially true for residential construction. For a typical structure, an area is surveyed and the land prepared to receive the foundation. A foundation crew builds the forms for the foundation, places reinforcement bar or bar screen mesh within the form, coordinates the delivery of the concrete, and smoothes or otherwise finishes the slab. After several days of curing, the frame of the foundation form is removed and the framing crew begins its efforts. The framing crew is responsible for erecting the framing around the house, including the bottom plates, studs, headers, top plates, joists, rafters, soffits, and other structures to the walls, ceiling and roof. The framing crew also generally places an insulation barrier on at least exterior walls to prepare for an outside finish. A roofing crew then arrives to place a roof, typically shingles or tile, on the framed deck prepared by the framing crew. This process is known as “drying in.” If the exterior surface is to receive a masonry exterior, then a masonry crew then begins the process of laying brick, stone, stucco, or other exterior surfaces. Alternatively, if wood is desired, then the framing crew can apply the boards to the exterior. A finishing crew is responsible for the interior cabinetry, trim, wall coverings, and other internal aspects. At various points along the process, the plumbing, electrical, heating and air conditioning, and other crews are responsible for roughing in, wiring, and installing the various lights, fans, built-in appliances, duct work, outlets, commodes, showers, bathtubs, sinks, and other aspects of a building. The above process can take from start to finish several months and in current prices can be in the range of $75 to $200 per square foot of construction depending on the style and design. The price is increasing as materials become more expensive, especially wood products.

An alternative to the above typical construction is trailer housing. Trailer housing is less expensive and portable, but is generally not of the quality of the above construction. However, trailer construction offers an alternative and in many cases very practical alternative. Typically, the trailer housing is similar to the above construction. However, the foundation is a foundation of steel beams and plates. Similar to the above, the walls are erected, a “skin” of metal or wood is generally placed on the outside of the interior, and interior paneling, plastic or other covering, is placed on the inside with insulation therebetween. The plumbing and electrical specialties are installed at various points of the process. The trailer housing can still be relatively expensive. Further, while the trailer housing is portable, special rigs and expertise must be hired to move the trailer to the site location.

Yet another alternative, at least for large commercial buildings, is tilt wall construction. Generally, the slab foundation is formed as described above. Tilt walls, fabricated offsite, are delivered to the site in relatively large panels weighing several tons. The panels require cranes and other heavy equipment for the erection of the walls with specialized expertise. Further, the tilt wall construction is generally applicable only to exterior walls. Interior walls are still required. Typically, the interior walls will include framing, such as steel framing, and exterior covering to the framing, such as paneling, sheetrock, or other coverings.

Thus, those seeking a new structure are generally required to choose between extensive onsite construction that is expensive and time consuming, purchased trailer housing that can still be expensive, and tilt wall construction that requires specialized equipment and trade skills.

Thus, there remains a need for relatively simple construction system that is efficient in use of time and resources.

### SUMMARY OF THE INVENTION

The present invention provides a simplified construction module system and method to form a structure by a minimal crew with little specialized trade skills and minimum equipment in a relatively short time period. Relatively lightweight construction modules can be brought to a construction site and linked together to form the structure. In at least one embodiment the present invention includes foundation modules, wall modules, ceiling modules, and roof modules. Further, the modules can be subdivided into specific modules that can be interchanged with other modules, including a door module, window module, and sub-modules. A designer can simply choose between the various modules depending on the size and layout desired. Other building trades such as finishers, plumbing, and electrical can complete the structure as needed. One or more of the modules can be filled after erection on the jobsite with a filler to add strength or stability to the structure.

The disclosure provides a construction module system, comprising: a first module having multiple surfaces around a cavity forming a three dimensional object with a hollow portion, the module having an opening through at least one first module surface, the first module further comprising a protrusion; a second module having multiple surfaces around a cavity forming a three dimensional object with a hollow portion, the module having an opening through at least one second module surface, the second module further comprising a receiver adapted to receive the protrusion to couple the second module with the first module to form an assembled structure; and the first module and the second module being adapted to communicate a pourable material between the opening in the first module surface and the opening in the second module surface when the modules are coupled together.

The disclosure provides a construction module system, comprising: a first foundation module comprising a first series of protrusions, receivers, or combination thereof; a second foundation module comprising a second series of protrusions, receivers, or combination thereof, the second module being adapted to be coupled with the first module to form a foundation of a structure; a wall module comprising a series of protrusions, receivers, or combination thereof adapted to be coupled to the first and the second series of protrusions, the receivers, or combination thereof; wherein the first series of protrusions, the receivers, or a combination thereof is preformed prior to coupling the foundation modules together to coordinate with the second series of protrusions, receivers, or a combination thereof so that a wall formed of one or more of the wall modules can span the first and second foundation modules and be coupled with both of the first and second series of protrusions, receivers, or combination thereof.

The disclosure further provides a method of protecting a building structure, comprising: building a removable at least partial protective shell around the building structure by coupling a plurality of removable modules together, the modules comprising multiple surfaces around a cavity forming a three dimensional object with a hollow portion and a series of preformed protrusions, receivers, or combination thereof to allow the coupling.

### BRIEF DESCRIPTION OF THE DRAWINGS

A more particular description of the invention, briefly summarized above, can be realized by reference to the embodiments thereof that are illustrated in the appended drawings and described herein. However, it is to be noted that the appended drawings illustrate only some embodiments of the invention. Therefore, the drawings are not to be considered limiting of its scope, for the invention may admit to other equally effective embodiments. Like elements will be numbered consistently throughout the figures.

FIG. 1 is a schematic perspective view of one embodiment of the construction module system.

FIG. 2 is a cross-sectional schematic view of a wall module coupled with a foundation module.

FIG. 3 is a cross-sectional schematic view of a wall module coupled with a foundation module with an opening therebetween.

FIG. 4 is a cross-sectional schematic view of a wall module coupled to an adjacent wall module.

FIG. 5 is a schematic cross-sectional top view of a module having other layers coupled thereto.

FIG. 6 is a schematic perspective view of a foundation module.

FIG. 6A is a schematic cross sectional view, illustrating an adjustment option on the foundation module.

FIG. 7 is a schematic top view of a foundation layout having a plurality of foundation modules.

FIG. 8 is a schematic top view of an alternative foundation for the construction module system.

FIG. 9 is a cross-sectional schematic view of a module having an opening formed therein.

FIG. 10 is a schematic cross-sectional view of a module having connectors coupled thereto.

FIG. 11 is a schematic perspective view of a ceiling module having an opening formed therein.

FIG. 12 is a schematic perspective view of an interior wall.

FIG. 13 is a perspective schematic view of a protective shell.

FIG. 14 is an enlarged cross sectional top schematic view of a column and a wall module portion.

### DETAILED DESCRIPTION OF THE INVENTION

In the description that follows, like elements are marked throughout the specifications and drawings with the same reference numerals, respectively. The drawing figures are not to scale. The elements are generally shown in schematic form in the interest of clarity and conciseness.

FIG. 1 is a schematic perspective view of one embodiment of the construction module system. A construction module system 2 generally includes one or more modules that can be coupled together to form a building or other structure 3 of a variety of shapes and sizes. Such structures can include without limitation, residences, garages, storage facilities, buildings, schools, emergency facilities, and so forth. Further, the construction module system can form protective shells over such structures, including mobile homes and other portable structures, that are particularly prone to damage in high winds. In some embodiments, the modules can be removable, for example, after a protective shell is needed. The structure can include a foundation 4, a wall 10, and a roof 30. Each portion of the structure can include one or more modules coupled together to form that particular portion. It is intended that a relatively small crew of two or more persons can readily assemble the modules or sub-modules to build the overall structure and if necessary other trades can add utilities, such as electricity and plumbing. The modules are generally constructed of weather resistant materials. In some embodiments, the materials can be heat or fire resistant, water resistant, insulating, non-condensing, or a combination thereof.

The size, shape, and layout of the modules can vary. If necessary, the modules can be coded in some fashion, such as by color or numerically, to identity its respective position in the overall structure to assist in assembly. A software program can be used to allow a designer or other persons such as the end user assistance in selecting and laying out an intended structure. Further, the design or layout can include openings, modules, and other places for heating, venting, and cooling in the floor, walls, or ceilings.

The foundation 4 can include one or more foundation modules 6. A foundation module 6 can be coupled joined at a foundation seam 8 to another foundation module. The foundation module can vary as described in more detail in reference to FIG. 7. The term “coupled,” “coupling,” and like terms are used broadly herein and can include any method or device for securing, binding, bonding, fastening, attaching, joining, inserting therein, forming thereon or therein, communicating, or otherwise associating, for example, mechanically, fluidically, magnetically, electrically, chemically, directly or indirectly with intermediate elements, one or more pieces of members together and can further include integrally forming one functional member with another. The coupling can occur in any direction, including rotationally.

Similarly, the wall 10 can include one or more wall modules. For example, the wall 10 can include a wall end module 12, a door module 14, a window module 16, and other modules. One or more of the modules can have an opening such as a door opening 15 in the door module 14 and a window opening 17 in the window module 16, generally collectively referred to as “pass through openings” herein. Advantageously, the modules are generally interchangeable so that the position of the respective modules, such as the door module, can be interchanged with other modules around the structure.

Further, the wall 10 with its respective modules (or other portions of the structure's modules) can include sub-modules. For example, a window sub end module 18 can be smaller than a regular sized wall module. Advantageously, the sub-modules can be incrementally sized, such as one-half or one-third, of a wall module to help maintain interchangeability between the various modules, if desired. Further, a sub-module can assist in staggering a seam of a wall module, such as seam 9, at a different location than a foundation seam 8. This staggering, similar to laying brick on a wall, can help provide structural integrity. The wall 10 can also include one or more wall universal modules 20 and other sub end modules 22 that may or may not have various openings therethrough.

The modules of the wall 10 or other portions of the structure can further include a first surface layer 24, which can be an outer layer. The first surface layer may be coupled to the wall 10 or other portion, including integrally formed thereon. The first surface layer 24 can be formed in a decorative fashion, such as representing brick, stone, wood siding, stucco, or other attractive appearances.

The roof 30 can be formed from one or more roof modules. For example, a roof end module 32 can be disposed at appropriate locations on the roof, such as at an end. The roof end module 32 can be coupled to a roof universal module 34. Further, the roof 30 can include a roof opening module 36. The roof opening module 36 can include one or more openings 37. The opening 37 can provide a preformed opening for a vent through the roof, piping, or even a chimney.

An end of the roof may need enclosing relative to the wall 10. To provide a transition, the construction module system 2 can include a wall-to-roof transition portion 40. The transition portion 40 can include a tapered module 42. The tapered module 42 can form a transition between the generally horizontal level surface of the wall 10 to the angular portion of the roof 30. A transition universal module 46 can be coupled to the tapered module 42 to fill in additional space. The tapered module 42 can be disposed adjacent the universal module 46 to transition to the other side of the roof 30, as appropriate. The number of tapered modules 42 and universal modules 46 can vary depending upon the size of the construction module system 2 and the number of foundation and wall modules used. A top cap module 44 can complete the transition between the wall 10 and the roof 30. For efficiency, the roof 30 can have a constant angle with respect to the wall 10 to assist in uniformly producing and erecting the transition portion 40, although the number of pieces may vary depending upon the width of the structure being assembled.

FIG. 2 is a cross-sectional schematic view of a wall module coupled with a foundation module. In general, the modules described herein can have preformed protrusions, receivers, or a combination thereof to facilitate coupling the modules together for form the structure or portion thereof. In at least one embodiment, the foundation 4 can be preformed with one or more receivers around the foundation 4. The wall 10 and the modules forming the wall can be preformed with one or more protrusions 48 that are sized and spaced to engage the one or more receivers 54. As will be described below in more detail, in general, this arrangement allows a foundation to be placed, and in modular fashion, the wall 10 to be erected on the foundation in relatively quick order.

Further, the wall, roof, and/or foundation modules may be hollow in that the surfaces of the modules may form a cavity therein. For example, the foundation 4 may have a hollow portion 52 and the wall 10 may have a hollow portion 26. In general, it will be advantageous to fill with a pourable the hollow portions of at least some of the modules with a substance to add structural integrity, insulation, or other desired effects to the modules. In some embodiments, the filling however may be unnecessary or undesirable. If filling is used, then one or more openings, such as opening 60 into wall 10 and/or opening 64 in the foundation 4, may be formed through which filler can be placed in the modules. In at least one embodiment, the filler can be hardenable fluid such as concrete, a foaming insulation, a moldable product, or other structural materials. In another embodiment, the filler can be a pourable sand or other granulated substance that can be hardenable or can remain in loose fashion. In yet another embodiment, the filler can be a liquid or gel that again can be hardenable or stay in a liquid or gel form. For ease of assembly, it is believed that the modules will generally be erected first and then the filler placed therein. However, in some embodiments, it may be advantageous to place the filler in the module prior to modular placement.

FIG. 3 is a cross-sectional schematic view of a wall module coupled with a foundation module with an opening therebetween. The embodiment of FIG. 3 is similar to the embodiment shown in FIG. 2. However, the embodiment in FIG. 3 illustrates an alternative opening for allowing filling of the modules when coupled together. For example, the wall module 10 can include an opening 50 through the protrusion 48. The foundation 4 can similarly include an opening 56 through the receiver 54. When the wall 10 and the modules forming the wall are coupled to the foundation 4 and the protrusion 48 has engaged the receiver 54, the openings 54 and 56 are fluidically coupled together. Thus, filler that can be used at least partially fill the wall 10 can flow through the opening 50 and into the foundation hollow portion 52 of the foundation 4.

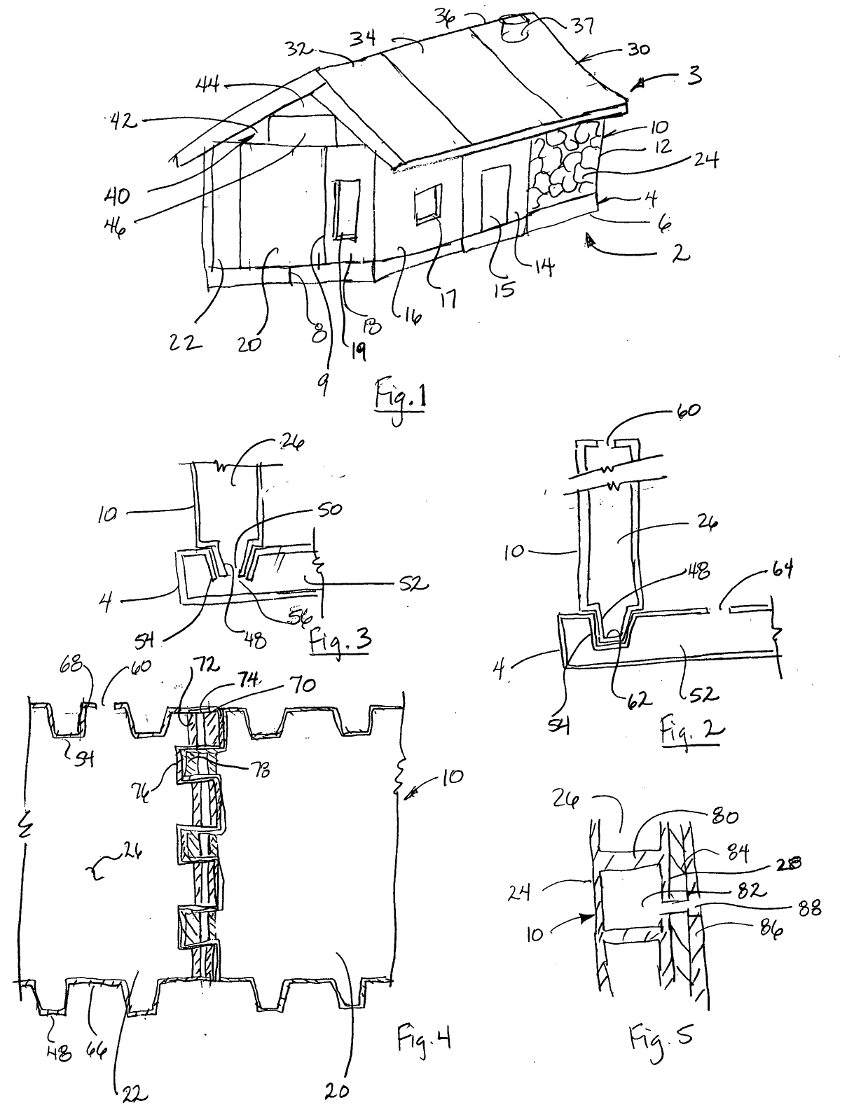

FIG. 4 is a cross-sectional schematic view of a wall module coupled to an adjacent wall module. A wall module, such as a sub end module 22 for illustrative purposes, can be coupled to another wall module, such as a wall universal module 20. The coupling can occur in a number of ways as would be known to those who are skilled in the art, given the disclosure contained herein. In at least one embodiment, the coupling can occur in alternating engagement of opposing portions of each wall panel. For example, a receiver 76 formed in a sidewall of the module 22 can receive a protrusion 78 correspondingly formed in the adjacent module 20. The protrusion and receiver can alternate between the panels. Further, an opening 70 can be formed in the receiver 76 and aligned with a similar opening in the protrusion 78 to allow insertion of a connector 74 therethrough. The connector 74 can include fasteners such as bolts, rods, pipe and conduit, and other linking members. Due to stress considerations, one or more of the openings 70 can be reinforced by a reinforcement portion 72. While the wall modules are illustrated in a stacked vertical position, it is to be understood that the wall modules and other modules can be stacked in a horizontal position, for example, if a thicker wall were desired. The protrusion 48, receiver 54, connector 74, and other coupling devices could be adjusted to accommodate different orientations, as would be known to those in the art given the disclosure contained herein.

The schematic also illustrates one or more protrusions 48 coupled to the wall modules that can engage the foundation 4 as described in reference to FIGS. 2 and 3. A support surface 66 can be formed in between protrusion 48 and another protrusion. The support surface 66 can be supported by a corresponding surface on the foundation 4 or in some cases by a lower wall module, if the wall is sufficiently high. Alternatively, the protrusion 48 and its relative engagement to a corresponding receiver, such as receiver 54 described in reference to FIGS. 2 and 3, can be used to support the wall module.

If the wall module is sufficiently high, then additional wall modules may be used to complete the height of the desired wall 10. Therefore, additional receivers 54, similar to the receiver 54 in the foundation described in reference to FIGS. 2 and 3, can be formed in the top portion of the wall modules 20, 22, and other wall modules. Also, a support surface 68 can be formed on the top of the wall module (or on the top of the underlying foundation module) to correspond to a surface that would engage a support surface 66 on the bottom of a wall module. The wall module can have one or more openings 60 formed in a portion, such as a top portion of the wall module, through which filler can partially fill a hollow portion 26 formed in the wall module.

FIG. 5 is a schematic cross-sectional top view of a module having other layers coupled thereto. The module generally includes a first surface layer 24 and a second surface 28. For example, if the wall panel is an outside wall panel, then the first surface 24 can be an outer layer of the wall panel facing a space external to the structure and the second surface 28 can be an inner layer of a wall module facing an internal space of the structure. Similarly, surfaces 24, 28 can be an upper layer and a lower layer of a ceiling or roof module. At least one of the surfaces, 24, 28, can include other layers coupled thereto. For example, layer 84, coupled to the surface 28, can represent an insulation layer. Still further, a layer 86, coupled to the layer 84, can represent a sheet rock or paneling layer, as may be desirable or suitable for the particular structure. One or more layers can also be coupled to the first surface layer 24.

Further, the modules may include a cross member 80. The cross member 80 can assist in supporting the module across the hollow portion 26 or other hollow portions formed in the module by providing structural integrity across the void. Further, a pair of cross members 80 can form an opening 82 therebetween. The opening 82 can be filled with filler, as has been described above. Alternatively, the opening 82 can provide a passageway for plumbing, electrical, vents, and other utility and appliance connections. For example, an opening 88 can be formed in a portion of the module through which plumbing, such as piping or electrical conduit or wiring, can enter the space adjacent the module. The cross members on either side of the opening 82 can seal adjacent hollow portions so that the adjacent hollow portions can still be filled at least partially with a filler. The opening 88 can provide also a mounting surface for various utility service outlets such as electrical outlets, water faucets, drain lines, and other utilitarian functions that need access through a wall, ceiling, roof, or even a foundation.

FIG. 6 is a schematic perspective view of a foundation module. The foundation 4 can include one or more foundation modules as described above. For example, the foundation can include a module that is formed with one or more receivers 54 that may be disposed along an exterior edge of the foundation. Further, one or more interior receivers 54a can be also formed in the foundation 4. It is to be understood that the protrusion/receiver relationship is for illustrative purposes only—other coupling methods can be used as would be known to those with ordinary skill in the art given the disclosure contained herein.

The modules of the foundation 4 can be coupled to each other by a similar receiver/protrusion relationship. For example, one edge of a module can include a protrusion 91 and a receiver 93. Another edge can include a protrusion 90 and a receiver 92. The relative spacing and placement of the protrusions and receivers can allow adjacent foundation modules to be coupled to each other. Further, an opening 94 can be formed through a protrusion and/or receiver to allow a connector 96 to be inserted through the receiver and/or protrusion when an adjacent module is coupled thereto to help secure the coupling between the adjacent modules. In some embodiments, it may be desirable to offset the engagement axis of the opening 94 on one side of the module from an engagement axis on another side of the module. In such instances, the engagement axis could be at a different elevation. Such an offset would need coordination with an adjacent module to ensure proper coupling, as necessary.

FIG. 6A is a schematic cross sectional view, illustrating an adjustment option on the foundation module. One or more of the modules, generally the foundation modules, can optionally include an adjuster 98 with a corresponding adjuster opening 99 in the module. Other types of adjusters can be used and the embodiment shown is for exemplary purposes and non-limiting. The adjuster 98 can include an enlarged portion for contact with the underlying substrate to the foundation. The adjuster 98 can be used to level the foundation module, before, during, or after installation on the substrate. The module can include one or more adjusters at various locations throughout the module.

FIG. 7 is a schematic top view of a foundation layout having a plurality of foundation modules. The foundation 4 can include one or more foundation modules. In some simple structures, the foundation modules generally described as foundation module 6 in reference to FIG. 1 can be used. In some structures having various design needs, different foundation modules can be coupled together to form the overall foundation 4. The following example is illustrative only and other examples are certainly possible. For example, a foundation universal module 100 can be used in various portions of the foundation 4 such as on a corner. A foundation “T” module 102 can be used to help support one or more interior walls. A foundation “L” module 104 can be used to support one or more interior walls at a different spacing than the foundation “T” module 102. A bathroom foundation module 106 can also be used to form a structure to support various plumbing needs of a bathroom that may need extra support or extra access, for example, through the particular foundation module. An exterior module 108 can be used when it is desired to simply support an exterior wall. A corner module 110 can also be used to simply support an external wall on a corner. In some embodiments, the corner module 110 will be similar to the “L” module 104. A kitchen module 112 can be designed to accommodate various standard needs of a kitchen, such as cabinet supports, sink access, interior and/or exterior walls, and other common needs. A “P” module 114 can be used to form one or more walls, such as walls for a closet, in close proximity to each other. A cross module 116 can generally be used as an interior module to couple corners of interior walls between adjacent modules.

The aforementioned modules are exemplary only and can be arranged in various fashion to accommodate the design of the structure. For example, kitchen modules can be placed at various locations and various interior and exterior walls coupled thereto, as may be desired or planned. The “T” module 102 can be used at interior portions such as adjacent to the cross module 116 to define a series of supports for interior walls that form a larger room overlapping two or more modules. Similarly, “T” modules and/or “L” modules can be coupled to the kitchen modules 112 to accommodate larger rooms that may overlap two or more modules. Further, such positioning with the respective receivers can be used to create intermediate walls, counters, and other surfaces.

As described above, the various modules can include receivers (or protrusions) as may be suitable for the particular module. It is believed that a representative variety of foundation modules, wall modules, roof modules, and ceiling modules can provide sufficient customization for many structural needs and desires of the consumer.

The modules can include one or more series of coupling elements, such as the receivers described above. For example, the universal module 100 can include a first series 118, a second series 119, a third series 120, and a fourth series 121. In the arrangement illustrated (and only for illustrative purposes) the universal module 100 can be placed at a corner so that the first series 118 and the fourth series 121 can be used to support an external wall. One or more of the interior series 119, 120 can be used to support an internal wall if appropriate. Similarly, the “T” module 102 can include a first series 123 and a second series 124. In the arrangement illustrated in FIG. 7, the first series 123 can form an exterior series to receive an exterior wall module in alignment with the first series 118 of the universal module 100. The second series 124 of the “T” module 102 if desired can be used to couple an interior wall module (not shown) to the foundation. The proximity of the first series 124 in the module 102 to the second series 119 of the module 100 could allow interior walls to form a reduced space that is smaller than a full module, such as an entryway, closet, vestibule, pantry, or another relatively small space. The cross module 116 can be used to complete one or more walls or interior portions of the foundation 4. For example, a series 140 of a module 114a can be aligned with a series in the cross module in one direction and series 124 of the module 102 can be aligned with a series in the cross module in another direction. Each of those series could support an interior wall module that could form a larger room in conjunction with, for example, the universal module 100 and the exterior series formed in that module. The enlarged room could bypass use of the second series 119 and third series 120 of the universal module 100 to form the larger room. Alternatively, the series 119 and 120 could be used to form a reduced height wall such as a bar, counter, or other appropriate structure.

Similar combinations can be made with the kitchen module 112 in combination with its series 132 and adjacent series 136 and 138 of the adjacent module 114, and series 134 of an adjacent module on another edge of the kitchen module 112 as shown. For example, the main kitchen could be formed on the kitchen module 112 and extended to series 134. Series 136 and 138 could form a pantry with a suitable interior wall having a door opening. A second door opening in an interior wall could be mounted on one of the series in the cross module 116 to allow ingress and egress into the kitchen area.

The bathroom module 106 can include one or more openings in the module. For example, an opening 126 can either be a partial opening that does not substantially go through the entire thickness of the module 106 or can be an opening that goes fully therethrough. The opening 126 can provide access for other building trades, such as a plumber, to lay drainage, sewage, and water lines therethrough. The opening can afterwards be sealed with some substance, such as concrete, poured into the opening, so that appliances or fixtures can be mounted thereon, such as commodes, shower stalls, and so forth. Opening 128 can be a larger opening that might accommodate a bathtub or other larger opening and through which various utility lines may be placed. In a similar fashion, an opening 130 in the kitchen module 112 can be used to place drainage lines, water lines, electrical and other utility connections for sinks, waste disposals, and other appliances.

Thus, a building structure can be completed by the proper selection and then assembly of the modules in a relatively short and standardized fashion. In general, it is believed that the foundation modules will include receivers below the top surface of the foundation module. Thus, any receivers that are not used may be filled with a filler, such as a hardenable material like concrete, to facilitate walking over the surfaces. Still further, other form of coverings can be mounted to the foundation surfaces, such as carpet, vinyl, and other floor coverings.

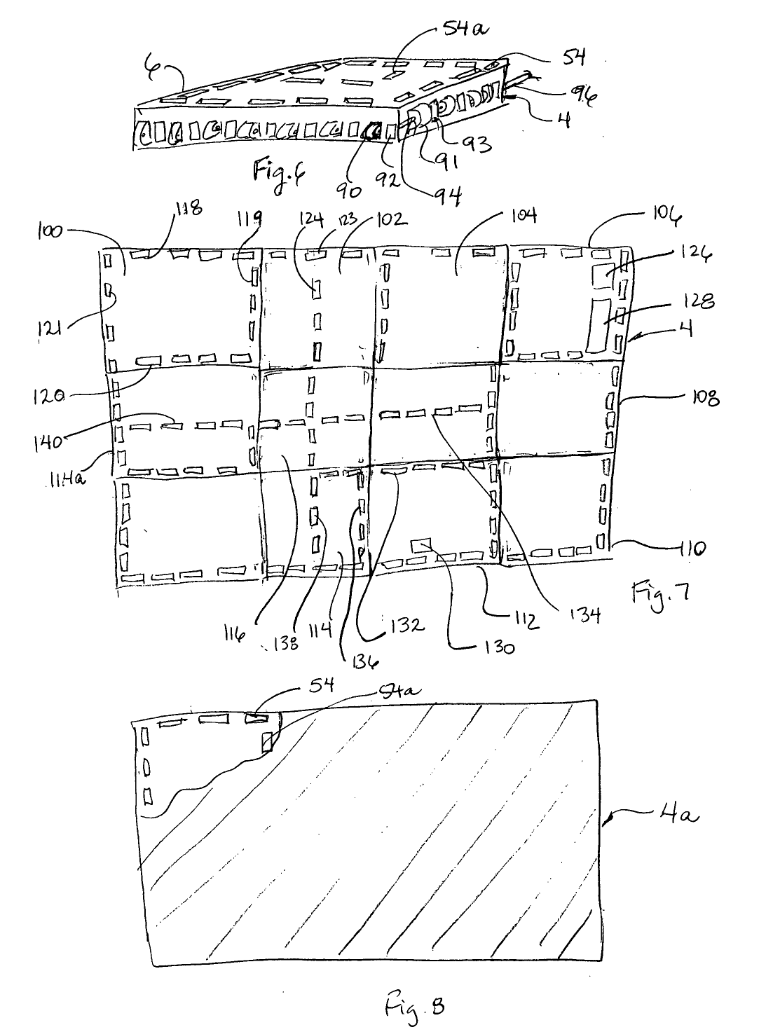

FIG. 8 is a schematic top view of an alternative foundation for the construction module system. An alternative foundation 4a could be a poured concrete foundation that could be suitable or desired for some installations. Further, the foundation 4a could include a pier-and-beam foundation or other foundations as may be appropriate to the site. In some instances, such as remote locations, the foundation 4a could simply be made of soil, rock, or other suitable surface into which receivers 54 and/or 54a are formed to receive these wall modules described herein.

The upper surface of the foundation 4a can be formed with receivers 54 and interior receivers 54a as may be appropriate to the particular layout. The foundation 4a could be used to support the wall modules, ceiling modules, roof modules, and other modules described above.

FIG. 9 is a cross-sectional schematic view of a module having an opening formed therein. From the various pass through openings 141 described herein, such as door opening 15, window opening 17, window opening 19 and other openings, it may be advantageous to provide a mounting surface for a structural element, such as a door or window, to fill the particular opening. A connector 142 could be coupled to the particular module in a variety of ways and upon which the door, window, or other element is mounted. For example, the connector 142 can be coupled to the module by adhesive, fasteners, or molding a reinforced section to the opening of the module. The connector 142 can be metallic, wood, plastic, or other structural material. The openings 141, such as windows, and doors, can further include adverse weather protectors, such as built-in hurricane coverings, and/or couplers 145 for the weather protectors to allow coupling of the weather protector over the openings 141.

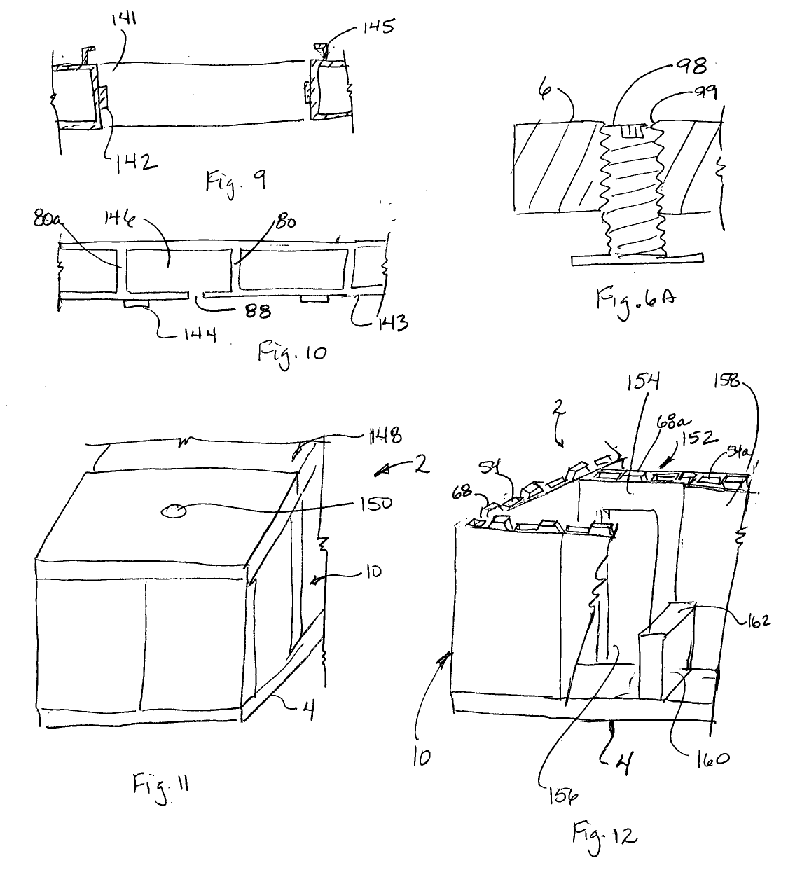

FIG. 10 is a schematic cross-sectional view of a module having connectors coupled thereto. In some modules, such as wall modules, ceiling modules, roof modules, and perhaps foundation modules, one or more appliances or fixtures or cabinetry may need attachment thereto. One or more connectors 144, similar to connector 142 described in reference to FIG. 9, can be coupled to the surface 143 of a particular module. Further, some modules may have an opening 146 formed therein featuring one or more cross members 80, 80a, or other supports. In some embodiments, the opening 146 can function as a utility opening through which plumbing, electrical, vents, and other components of a typical structure can be placed. Further, one or more openings 88 can be preformed or formed at the site through which the various conduits, lines, wiring, and so forth can be routed through the surface 143.

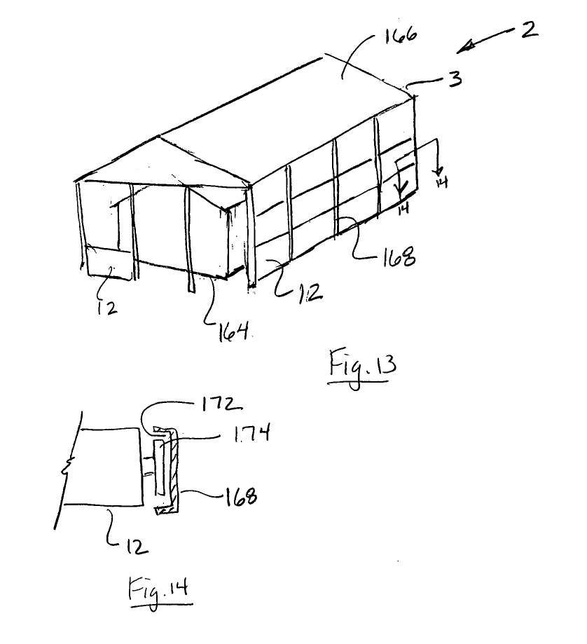

FIG. 11 is a schematic perspective view of a ceiling module having an opening formed therein. The construction module system 2 can further include one or more ceiling modules 148. Ceiling modules are generally mounted on top of the wall 10, where the wall 10 can include exterior or interior wall modules, described herein. In one embodiment, a ceiling module can include an opening 150 at least partially formed therethrough. The opening 150 can facilitate mounting of ceiling fixtures, such as lights, fans, vents, speakers, and other generally known ceiling mounted objects. The ceiling modules 148 can be formed in a similar fashion as the foundation modules, in that the ceiling modules can include one or more receivers to receive various protrusions in an upper portion of the wall 10, as described in reference to FIG. 4. Other alternatives for coupling the ceiling modules to the wall modules can be made, as would be known to those with ordinary skill in the art, given the description contained herein.

FIG. 12 is a schematic perspective view of an interior wall. The construction module system 2 can further include one or more interior modules 152. For example, an interior wall module, such as interior wall universal module 158, can be used throughout interior portions of the structure constructed with the construction module system 2. In some embodiments, the interior wall modules 12 can be the same or similar to the exterior wall modules. For example, a universal module 158 can be similar to the universal module 20, described in reference to FIG. 1. An interior wall opening module 154 having an opening 156 can be used to form door openings, window openings, and other openings as may be appropriate to the particular inside design. In like fashion, the wall opening module 154 can be similar to the door module 14, the window module 16, or other modules described herein having openings therethrough. In some other embodiments, a sub module 160 can represent a shortened interior wall having an upper surface 162. The sub module 160 can be used to create attractive counters, room dividers, and other space designs as may be appropriate. The upper surface 162 on the sub modules can be smoothed to present a finished surface or can have different receivers and support services to support, for example, a counter top (not shown).

The upper portion of the interior walls can contain one or more interior recesses 54a and support surfaces 68a similar to the receiver 54 and support surface 68, described in reference to FIG. 4. In other embodiments, the top of the interior walls may be smooth, so that the ceiling rests thereon and the location of the ceiling panels may be controlled by the exterior walls. In still another embodiment, the interior walls could be formed without the receiver 54 and protrusion 68 in the upper portion of the wall so that the ceiling 150 is placed thereon and attached via a variety of other methods, as would be known to those skilled in the art given the present disclosure.

FIG. 13 is a perspective schematic view of a protective shell. FIG. 14 is an enlarged cross sectional top schematic view of a column and a wall module portion. The figures will be described in conjunction with each other. It is well known that the Gulf Coast has been hit by multiple large and devastating hurricanes in the last few years. Existing structures such a mobile homes, portable buildings, and other structures that are not anchored and as strong structurally as more permanent structures are particularly susceptible to wind and other damage. Mobile homes are often damaged by high winds, because their foundation does not rest on the ground and wind forces under the mobile home frames can topple the homes. Other types of protection can be useful such as protection from blizzards and driving snow, flooding, and other natural and man-made conditions. Even temporary protection can sometimes be all that is needed.

The construction module system 2 can also be used to build a structure 3 as a protective shell around another structure 164. The protective shell can includes one or more walls, a roof, a foundation, or a combination thereof. In at least one embodiment, a roof can be formed over the structure 164 that can include roof modules as described above. Alternatively, the roof can be a conventional roof with metal, asphalt shingles, tiles, and so forth. The walls are generally formed at least partially with a plurality of wall modules 12 described above. The wall modules can be coupled together in sections as appropriate.

The walls can be moved between a first position and a second position, where one of the positions is more protective than the other position. In at least one embodiment, the wall modules can be rotatably coupled together in a vertical fashion that can be raised and lowered as needed for protection. A plurality of columns 168 can assist in supporting and guiding the wall modules. For example and without limitation, the column 168 can form a guide channel 172 in which a guide 174 can move, where the guide 174 is coupled to the wall module 12. The guide 170 can be a wheel, post, or other guiding element. One or more sections can be raised and lowered when there are multiple sections coupled together. Alternatively, the wall modules can simply be removed and reassembled as necessary and thus a guide 174 may not be particularly useful.

The modules can be at least partially filled with the pourable material described above on site, such as when the modules are in a protective position to the protected structure. At least a portion of the pourable material can be emptied from the modules when the protective need ends to facilitate easier removal or movement of the modules.

While the foregoing is directed to various embodiments of the present invention, other and further embodiments may be devised without departing from the basic scope thereof. Other embodiments within the scope of the claims herein will be apparent to one skilled in the art from consideration of the specification and practice of the invention as disclosed herein. For example, various methods and systems for coupling the modules together can be had, as would be known to those with ordinary skill in the art, given the basis of the modular disclosure herein. It is intended that the specification, together with the example, be considered exemplary only, with the scope and spirit of the invention being indicated by the claims that follow.

The various methods and embodiments of the invention can be included in combination with each other to produce variations of the disclosed methods and embodiments, as would be understood by those with ordinary skill in the art, given the understanding provided herein. Also, various aspects of the embodiments could be used in conjunction with each other to accomplish the understood goals of the invention. Also, the directions such as “top,” “bottom,” “left,” “right,” “upper,” “lower,” and other directions and orientations are described herein for clarity in reference to the figures and are not to be limiting of the actual device or system or use of the device or system. Unless the context requires otherwise, the word “comprise” or variations such as “comprises” or “comprising”, should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. Further, the order of steps can occur in a variety of sequences unless otherwise specifically limited. The various steps described herein can be combined with other steps, interlineated with the stated steps, and/or split into multiple steps. Additionally, the headings herein are for the convenience of the reader and are not intended to limit the scope of the invention.

Further, any references mentioned in the application for this patent as well as all references listed in-the information disclosure originally filed with the application are hereby incorporated by reference in their entirety to the extent such may be deemed essential to support the enabling of the invention. However, to the extent statements might be considered inconsistent with the patenting of the invention, such statements are expressly not meant to be considered as made by the Applicant.

1. A construction module system, comprising:
a first module having multiple surfaces around a cavity forming a three dimensional object with a hollow portion, the module having an opening through at least one first module surface, the first module further comprising a protrusion;
a second module having multiple surfaces around a cavity forming a three dimensional object with a hollow portion, the module having an opening through at least one second module surface, the second module further comprising a receiver adapted to receive the protrusion to couple the second module with the first module to form an assembled structure; and
the first module and the second module being adapted to communicate a pourable material between the opening in the first module surface and the opening in the second module surface when the modules are coupled together.

2. The construction module system of claim 1, wherein the first module comprises a top, bottom, sides, front, and back surfaces, and the opening in the first modules is formed through at least one of the surfaces.

3. The construction module system of claim 1, wherein at least one of the modules comprises a foundation module for a foundation of a structure, a wall module for a wall of the structure, a roof module for a roof of the module, or a ceiling module for a ceiling of the structure.

4. The construction module system of claim 1, wherein the modules are adapted to be coupled together to form a structure comprising a protective shell.

5. The construction module system of claim 4, wherein the modules are adapted to be coupled together to create a protective shell over a mobile home.

6. The construction module system of claim 1, further comprising a plurality of different types of foundation modules having preformed protrusions, receivers, or a combination thereof and adapted to be coupled together to form a foundation of a structure.

7. The construction module system of claim 6, wherein a plurality of foundation modules are adapted to be coupled together so that a wall formed of one or more wall modules can span the plurality of foundation modules and be coupled to the foundation modules using the series of preformed protrusions, receivers, or a combination thereof.

8. The construction module system of claim 1, wherein at least one of the modules comprises a surface layer resembling brick, stone, stucco, or wood, or combination thereof.

9. The construction module system of claim 1, wherein the pourable material comprises a granular substance or a liquid.

10. The construction module system of claim 1, wherein at least one of the modules comprises a preformed pass through opening passing through the whole module for installation of a door or a window.

11. A construction module system, comprising:
a first foundation module comprising a first series of protrusions, receivers, or combination thereof;
a second foundation module comprising a second series of protrusions, receivers, or combination thereof, the second module being adapted to be coupled with the first module to form a foundation of a structure;
a wall module comprising a series of protrusions, receivers, or combination thereof adapted to be coupled to the first and the second series of protrusions, the receivers, or combination thereof;
wherein the first series of protrusions, the receivers, or a combination thereof is preformed prior to coupling the foundation modules together to coordinate with the second series of protrusions, receivers, or a combination thereof so that a wall formed of one or more of the wall modules can span the first and second foundation modules and be coupled with both of the first and second series of protrusions, receivers, or combination thereof.

12. The construction module system of claim 11, wherein at least two of the modules each comprise multiple surfaces around a cavity forming a three dimensional object with a hollow portion and an opening through at least one of the surfaces to communicate a pourable material between the modules.

13. The construction module system of claim 12, wherein the pourable material comprises a granular substance or a liquid.

14. The construction module system of claim 11, wherein the modules are adapted to be coupled together on site for form a structure comprising a protective shell.

15. The construction module system of claim 14, wherein the modules are adapted to be coupled together to create a protective shell over a building structure.

16. The construction module system of claim 11, wherein at least one of the wall modules comprises a preformed pass through opening passing through the whole module for installation of a door or window.

17. A method of protecting a building structure, comprising:
building a removable at least partial protective shell around the building structure by coupling a plurality of removable modules together, the modules comprising multiple surfaces around a cavity forming a three dimensional object with a hollow portion and a series of preformed protrusions, receivers, or combination thereof to allow the coupling.

18. The method of claim 17, further comprising pouring a pourable material into at least one of the modules on site.

19. The method of claim 17, further comprising allowing the modules to move into a first position and a second position, where one of the positions is more protective than the other position.

20. The method of claim 17, protecting the building structure comprises protecting a house, mobile home, portable building, or shed.
